(19) United States
(12) Patent Application Publication
(10) Pub. No.: US 2014/0202999 A1
(43) Pub. Date: Jul. 24, 2014

(54) FORMING A STRUCTURE

(71) Applicants: Andrew David Wescott, South Gloucestershire (GB); Jagjit Sidhu, South Gloucestershire (GB)

(72) Inventors: Andrew David Wescott, South Gloucestershire (GB); Jagjit Sidhu, South Gloucestershire (GB)

(21) Appl. No.: 14/237,669

(22) PCT Filed: Aug. 8, 2012
(86) PCT No.: PCT/GB2012/051927

§ 371 Date: Feb. 7, 2014

(30) Foreign Application Priority Data
Aug. 10, 2011 (GB) 1113758.5

(51) Int. Cl. B23K 26/00

(52) U.S. Cl. CPC B23K 26/0066
USPC 219/121.85

(57) ABSTRACT

Apparatus and a method of forming a structure (304) are disclosed. The method includes applying a heat treatment to a first area (206) on a first surface (201A) of a work piece (200), wherein at least one dimension of the first area corresponds to a maximum design dimension of a structure (304) to be formed. The structure is then formed on a second area (303) on an opposite surface (201B) of the work piece, the second area having a location corresponding to the first area.

The present invention relates to forming a structure.

Structures can be formed using many known techniques, such as connecting components together by welding or the like, or by other, more advanced techniques. Additive Layer Manufacture (ALM) is an advanced manufacturing method and is becoming increasingly important in many applications, including aerospace and defence. ALM is a broad term used to describe a wide variety of technologies but generally involves the repeated layering of a desired material in order to create structural components. This addition of material might be to an existing structure in the form of a cladding, repair or the addition of fixings, or it may be the free form deposition of a material to form a new, independent structure. ALM processes are lean and agile production techniques, which have the capacity to significantly influence manufacturing.

ALM is a consolidation process that produces a functional complex part layer by layer without any moulds or dies. A laser implemented version of the process uses a laser beam to melt a controlled amount of injected metallic powder on a base plate to deposit the first layer and on succeeding passes for the subsequent layers. As opposed to conventional machining processes, this computer-aided manufacturing (CAM) technology builds complete functional parts or features on an existing component by adding instead of removing material.

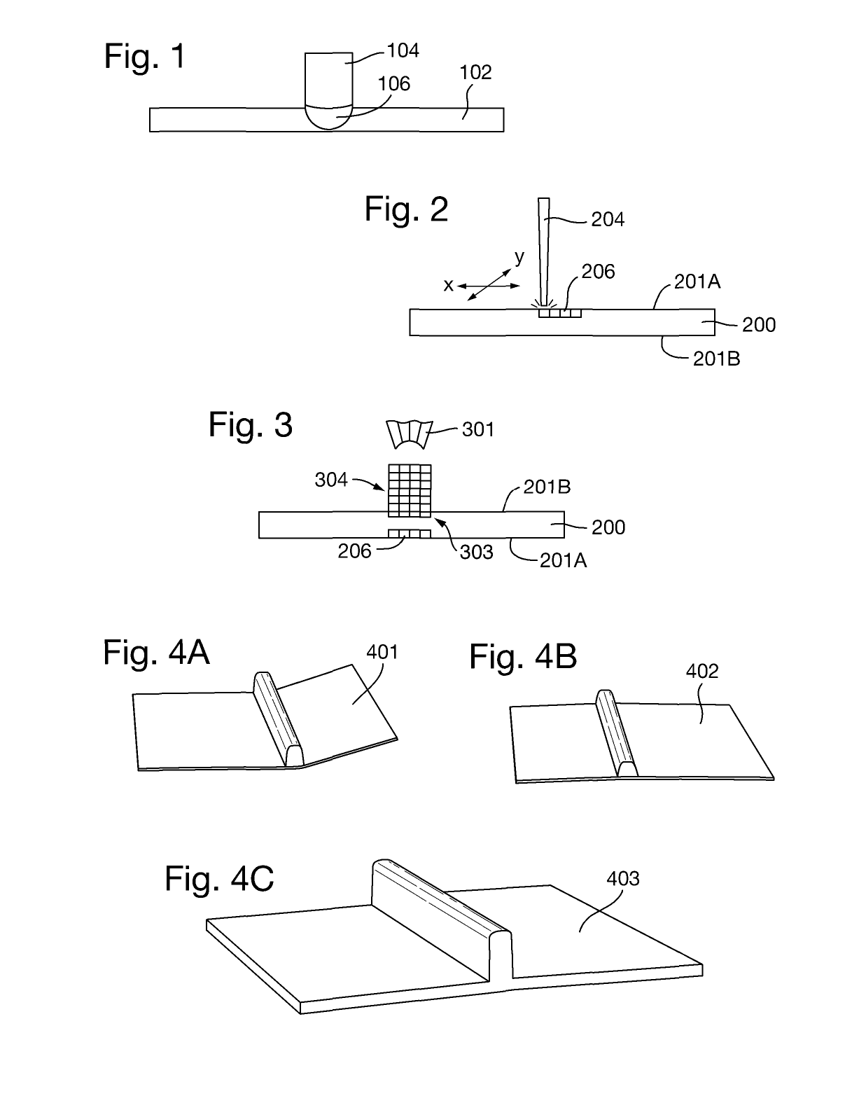

FIG. 1 illustrates schematically a cross section through a work piece 102 and structure layers 104 formed by a conventional ALM process. During deposition of the initial layer(s) the laser beam of the ALM apparatus creates a weld pool 106 on the work piece. During this weld pool creation the work piece is subjected to intense localised heating creating steep thermal gradients between the molten material and the cold material further out. If the transverse compressive stresses caused by the very hot expanding material exceed that of the material's yield point then compressive plastic yielding (CPY) will occur in the surrounding material. On cooling and shrinkage high tensile transverse residual stresses across the “weld” will be created and these will be balanced by compressive residual stresses further out. These compressive residual stresses cause buckling distortion when they exceed the critical buckling load (CBL) of the work piece, particularly in thin section material.

The present invention is intended to address at least some of the abovementioned problems. The invention can provide a method of eliminating/reducing distortion by pre-stressing the parent material on one side by laser treatment, prior to building a structure on the opposite side, e.g. by means of an ALM process. In some embodiments CPY is not eliminated but distortion is neutralised by balancing tensile and compressive residual stresses from the pre-scan and the structure build.

According to first aspect of the present invention there is provided a method of forming a structure, the method including:

applying a heat treatment to a first area on a first surface of a work piece, wherein at least one dimension of the first area corresponds to a maximum design dimension of the structure, and then

forming a structure on a second area on an opposite surface of the work piece, the second area having a location corresponding to the first area.

The heat treatment may be configured to pre-stress the work piece so as to balance residual stresses such as tensile and compressive stresses expected to result from the formation of the structure.

The heat treatment may be provided by a laser configured to scan the first area at least once.

A width of the first area may correspond to a maximum design width of the structure to be formed. The step of forming the structure on the second area may comprise a blown powder ALM process, a solid wire arc ALM process or a welding process.

According to another aspect of the present invention there is provided a structure formed by a method substantially as described herein.

According to yet another aspect of the present invention there is provided apparatus adapted to form a structure, the apparatus including:

apparatus adapted to apply a heat treatment to a first area on a first surface of a work piece, wherein at least one dimension of the first area corresponds to a maximum design dimension of the structure, and

apparatus adapted to form a structure on a second area on an opposite surface of the work piece, the second area having a location corresponding to the first area.

The heat treatment apparatus may comprise a laser, such as a Nd—YAG CW laser.

According to a further aspect of the present invention there is provided a work piece adapted for use in forming a structure, the work piece including:

a first area on a first surface, the first area pre-stressed by a heat treatment, and

a second area on an opposite surface of the work piece, the second area having a location corresponding to the first area, in use, a structure being formed on the second area.

Whilst the invention has been described above, it extends to any inventive combination of features set out above in the following description, claims or drawings.

By way of example, a specific embodiment of the invention will now be described by reference to the accompanying drawings, in which:

FIG. 1 illustrates schematically a weld pool formed by a conventional ALM process;

FIG. 2 illustrates a laser pre-treatment step of an example embodiment;

FIG. 3 illustrates an ALM build step of the embodiment;

FIG. 4A shows a work piece having a structure formed by conventional ALM processing, and

FIGS. 4B and 4C show work pieces having structures formed upon them according to embodiments of the present invention.

FIG. 2 is a schematic illustration of an example of the distortion control technique, which involves pre-stressing the reverse side of the plate using a single pass laser scan. The induced stresses resulting from this operation were found to be sufficient to act as balancing forces. The inventors discovered by experiment that the residual stress set up in the plate by the ALM build is done so by the first layer of deposition only. Further layers had little or no effect on distortion of the plate.

FIG. 2 shows a work piece 200. The work piece (also known as a “parent plate”) can be formed of any suitable material, typically a strong metal such as titanium, and can have any desired dimensions. The work piece can be held in place for ALM processing by a clamp (not shown) or the like. Typically, the work piece is positioned so that a first surface 201A faces a laser 204, with its opposite surface 201B facing downwards. The surface 201B is the surface on which a structure is to be subsequently formed, e.g. using an ALM process. The laser is configured to scan its beam along the upper surface 201A, over an area 206 having the same width as the maximum design width of the structure to be built. The laser may perform a single pass, or multiple passes if the structure to be formed has a width greater than the beam width. The amount of pre-bending required can be determined experimentally, e.g. the structure formation is first performed without correction on a test plate; the distortion in the test plate is then measured, and then a base plate (having identical/similar characteristics to the test plate) can be pre-bent by the amount of distortion measured in the test plate. Alternatively, this information can be obtained by means of simulation or calculation via heat transfer equations.

If the work piece is to have structures formed on it at other locations (e.g. after it or the nozzle of the ALM apparatus has been moved after forming the first ALM structure, as will be described below) then further areas on the surface 201A may be treated, typically after the first laser treatment, although it is possible that treated areas could be produced non-sequentially between structure builds.

Referring to FIG. 3, after the pre-treatment laser scan has been performed the work piece 200 is turned over (e.g. by hand or by robot) so that the un-treated surface 201B now faces the apparatus that is to used to create a structure upon it, e.g. the nozzle 301 of ALM apparatus. In an alternative embodiment, apparatus for performing the laser pre-treatment and the structure formation, could be located on opposite sides of the work piece so that changing its orientation is not necessary. The ALM apparatus is configured in a conventional manner to produce a structure having a particular design and dimensions. An ALM structure 304 is deposited onto the surface 201B, over an area 303 corresponding to the treated area 206 on the opposite/lower surface 201A. The work piece 200 may be separated from the structure 304 after the ALM processing has been completed.

In one embodiment a titanium Ti6Al4V parent plate/work piece was clamped in a jig along one edge allowing the free edge to bend highlighting levels of distortion. An Nd—YAG CW laser beam, with a spot diameter of 3 mm, was scanned across the surface to induce the pre-treatment levels of residual stress. A beam power of 1200W was used for the pre-treatment. It will be understood that in other embodiments, different types of heat sources can be used. The plate was then turned over and linear ALM builds were produced from titanium Ti6Al4V powder within an argon shielding environment at an oxygen concentration level of ˜10 ppm. However, it will be appreciated that the method described herein is also applicable to any engineering material, metallic or otherwise. The initial layer was built using a beam power of 1200W with subsequent layers build using 800W. Fully consolidated structures were built by scanning the laser across the substrate at 15 mm/sec, overlapping each individual scan by 1.7 mm, to produce a sample with a wall width of 7 mm. 40 layers of material were deposited whilst incrementing the deposition nozzle by 300 μm after each layer to produce a wall ˜12 mm in height. FIG. 4A shows a work piece 401 with a thickness of 2 mm that has had an ALM structure formed on it in a conventional manner, whereas FIG. 4B shows the same type of work piece 402 after being subjected to the laser pre-treatment and ALM processing described herein. FIG. 4C shows a work piece 403 having a thickness of 6 mm after being subjected to the laser pre-treatment and ALM processing described herein.

Improvements provided by embodiments of the present invention over conventional distortion control methods include:
No on-line stress engineering tools are required which apply global or local mechanical tensioning methods.
The requirement to carry out post build distortion control processes is mitigated.
The ability to build complex 2D or 3D conformal ALM structures and geometries.

The embodiments described above relate to an ALM structure being built on distortion free parent plate due to the laser pre-treatment. However, it will be understood that the technique is not exclusively limited to the demonstrated blown powder ALM method, but can be used in connection with other structure formation processes, such as wire fed ALM or even to conventional welding processes once the level of pre-stressing has been determined, e.g. by experiment, simulation or calculation, as mentioned above in relation to the powder blown ALM embodiment.

1. A method of forming a structure, the method including:
applying a heat treatment to a first area on a first surface of a work piece, wherein at least one dimension of the first area corresponds to a maximum design dimension of a structure to be formed, and then
forming the structure on a second area on an opposite surface of the work piece, the second area having a location corresponding to the first area.

2. A method according to claim 1, wherein the heat treatment is configured to pre-stress the work piece so as to balance residual stresses expected to result from the formation of the structure.

3. A method according to claim 2, wherein the heat treatment is provided by a laser configured to scan the first area at least once.

4. A method according to claim 1, wherein a width of the first area corresponds to a maximum design width of the structure to be formed.

5. A method according to claim 1, wherein the step of forming the structure on the second area comprises a blown powder ALM process or a solid wire arc ALM process.

6. A method according to claim 1, wherein the step of forming a structure on the second area comprises a welding process.

7. Apparatus adapted to form a structure, the apparatus including:
apparatus adapted to apply a heat treatment to a first area on a first surface of a work piece, wherein at least one dimension of the first area corresponds to a maximum design dimension of a structure to be formed, and
adapted to form the structure on a second area on an opposite surface of the work piece, the second area having a location corresponding to the first area.

8. Apparatus according to claim 7, wherein the heat treatment apparatus comprises a laser.

9. Apparatus according to claim 8, wherein the laser comprises an Nd—YAG CW laser.

10. A work piece adapted for use in forming a structure, the work piece including:
a first area on a first surface, the first area pre-stressed by a heat treatment and wherein at least one dimension of the first area corresponds to a maximum design dimension of a structure to be formed, and
a second area on an opposite surface of the work piece, the second area having a location corresponding to the first area, where, in use, the structure is formed on the second area.
